(19) United States
(12) Patent Application Publication
(10) Pub. No.: US 2011/0255075 A1
(43) Pub. Date: Oct. 20, 2011

(54) Spectrometric assembly and method for determining a temperature value for a detector of a spectrometer

(75) Inventors: Felix Kerstan, Jena (DE); Nico Correns, Weimar (DE)

(73) Assignee: CARL ZEISS MICROIMAGING GMBH, Jena (DE)

(21) Appl. No.: 13/120,821

(22) PCT Filed: Oct. 27, 2009
(86) PCT No.: PCT/EP09/07664

§ 371 Date: Mar. 24, 2011

(30) Foreign Application Priority Data
Oct. 31, 2008 (DE) 10 2008 054 056.0

(51) Int. Cl. G01J 3/28

(52) U.S. Cl. 356/72

(57) ABSTRACT

The invention relates to a spectrometric assembly and method for determining a temperature value for a detector of a spectrometer. It is conventional to record the detector temperature in an optoelectronic detector using a thermal temperature sensor in order to compensate for temperature fluctuations. Due to the finite distance between the detector and the temperature sensor, the accuracy of the temperature detection is limited. According to the invention, the detector temperature should be recordable at high accuracy and with little effort. In addition to means for spectral division of incident tight and an optical detector for spectrally resolved detection of a spectral range of the divided light, a second optical detector is provided for detection of a partial range of this spectral range as a reference detector, wherein sensitivity of the reference detector is substantially temperature-independent. The ratio of the signals of both detectors is a highly accurate measurement for the relative temperature of the first detector due to the temperature independence of the sensitivity of the reference detector, and can be determined with little effort.

The invention relates to an assembly especially for optical spectroscopy with means for spectral splitting of incidental light and an optical detector for spectrally resolved detection of a spectral region of the incident light as well as a method for determining a temperature value of an optical detector for spectrally resolved detection of a spectral region of incident light.

The sensitivity of an optoelectrical light detector, for instance a CCD or CMOS sensor depends especially on the temperature of the detector. This temperature-dependency of the detector sensitivity inhibits the measuring accuracy of spectrometers, especially near its upper limiting wavelength (at the long-wave end of the region of application).

In order to compensate for temperature swings, it is known to acquire the detector temperature by means of a thermal sensor. In DE 10 2005 003 441 A1 it is further described that a second temperature sensor can be utilized for more exact determination of the influence of the ambient temperature on the detector. Based on the determined detector temperature, it is possible to control a temperature unit of the detector, for instance heating or cooling, such that the detector temperature remains constant. In this way the accuracy of the measurement of the incidental luminous power on the detector can be improved. A temperature sensor, however, has the disadvantage that the temperature of the detector can only be determined with limited accuracy as the sensor cannot be arranged in or inside the detector but must always be arranged at a distance from the detector. Correspondingly also the accuracy of the compensation of temperature swings is limited.

Detectors with various materials for different wavelength regions are used for spectrometers. The upper limiting wavelength, especially, is a material property that must be taken into account in the development of spectrometers.

Materials with higher limiting wavelengths generally have the advantages of a larger usable spectral region and a lower temperature dependency of the sensitivity at a given wavelength. However, they are more expensive and have the disadvantage of a greater noise that can only be reduced by cooling.

The object of the invention is to improve the assembly mentioned at the start so that the detector temperature can be measured with a high degree of accuracy with little effort, especially the for the purpose of the compensation of temperature swings.

The task is solved by means of an assembly with the features mentioned in claim 1 and by a method that possesses the features mentioned in claim 12.

Advantageous embodiments of he invention are given in the subsidiary claims.

According to the invention, in addition to means for spectral division of incident light and an optical detector for spectrally resolved detection of a spectral range of the split light, a second optical detector is provided for detection of a partial range of this spectral range as a reference detector, whereby a sensitivity of the reference detector is substantially temperature-independent or at least significantly less temperature dependent than a corresponding sensitivity of the first detector. By means of the first optical detector there is determined a detector signal for a part region of the spectral region to be detected and by means of a second optical detector an (almost) temperature-independent reference signal for the same part region of the spectral region.

The luminous power falling on the reference detector is in almost constant relationship to the luminous power that the first detector acquires in the part region used for reference. Because of the substantial temperature independence of the sensitivity of the reference detector, the relationship of the signals of both detectors is a highly accurate dimension for the relative temperature of the first detector.

In order to determine the relationship, an integrated luminous power above the part spectral region is sufficient so that the reference detector does not need to be spectrally or spatially resolving. Thus, in comparison with the first detector, it can be implemented with substantially less size and with substantially simpler structure. Because of the, at least, approximate temperature-independence of the sensitivity of the reference detector, a cooling of the reference detector for the application according to the invention is not necessary. A thermal temperature sensor is also not necessary either for the first detector or for the reference detector.

Appropriately, the reference detector possesses a higher upper limiting wavelength than the first detector. In this way a lesser temperature-dependency of the reference detector is achieved.

Especially advantageous are embodiments in which the first detector (main detector) is silicon (Si detector) and the reference detector is an indium-gallium-arsenide-semiconductor detector (InGaAS detector).

Advantageously, the whole of the spectral region to be detected by means of the first detector and the part region of the spectral region to be detected by the reference detector are detectable simultaneously. The highest possible accuracy of the temperature value can be achieved with this simultaneity. The simultaneous detection of the whole of the part spectral region is arrived at in different ways.

In a first advantageous embodiment, the reference detector is assembled such that the light that is reflected from the first detector and spectrally resolved by it is detectable. In this manner a beam splitter and a band pass filter can be dispensed with. In addition, the effective sensitivity of the assembly is high; because the reference detector only receives light not detectable to the first detector. The luminous power detectable by the first detector remains unchanged despite the reference measurement.

In a second advantageous embodiment the means for spectral splitting include a depletive grid in which the reference detector is assembled such that because of it light is detectable in a different diffraction of the grid than through the first detector. In this manner a beam splitter can be dispensed with. A band pass filter can be dispensed with when the reference detector is not arranged in the zero order. However, with the placing of the reference detector in the direction of the zero diffraction order, the spectrometer can be made compact, which is especially advantageous for the assembly in a measuring head housing. In this case a band pass filter for the part region to be detected is necessary.

In a third advantageous embodiment a beam splitter is provided, by means of which a first fraction of the incident light is led to the first detector and a second fraction is led to the reference detector whereby the reference detector is provided with a band pass filter for the part region to be detected. Typically, the beam splitter is arranged in front of the entry slit of a spectrometer. This assembly can be set up with little effort, as the placing of the reference sensor in the incident light can be relatively coarse.

Usefully, a control unit is provided which based on a detection signal of the reference detector and on at least one detection signal that corresponds to the part region of the first detector, determines a relative temperature value for the first detector. This control unit, for instance, can be assembled together with the detectors in measuring head housing. The control unit can output the determined temperature value especially for later processing over an interface. For example, both the detection signals of the first detector as well as those of the reference detector can be passed on immediately to a primary control computer, that later corrects the temperature swings of the detection signals on the basis of the reference signals.

Advantageously, on the basis of the temperature values and on a sensitivity function of the first detector, the control unit corrects the direct detection signals of the first detector. In this way there is achieved the compensation of a temperature independence of a sensitivity of a spectrally resolved optical detector with a high degree of accuracy and with little effort.

Usefully, the temperature value is determined as a quotient from the reference signal and the detection signal. The correction signal from the output detection signal of the first detector of temperature-referenced swings can, for example, be carried out purely mathematically with little effort. In this way an expensive tempering unit is not required. The control unit will preferably output the corrected detection signal in place of the uncorrected detection signal, for example to a primary control computer or on to a memory medium. In this way the correction is transparent for the control computer or another form of further processing. The assembly according to the invention can therefore also be used with existing control computers without these having to be adapted.

Also possible are embodiments in which the control unit, in dependence of the temperature value, controls a tempering unit for the first detector. This embodiment also permits the compensation of a temperature dependence of a sensitivity of a spectrally resolved optical detector with a high degree of accuracy.

Advantageously, a sensitivity function of the first detector is measured during a warming up phase or is measured after a warming-up phase in order to avoid influences of swings due to production tolerances. Alternatively a detector manufacturer can use prescribed sensitivity functions.

The invention also includes a spectrometer with a light source and an assembly as described above. In addition, the spectrometer can be encapsulated as measuring head in an enclosed housing that can be connected for output of corrected or uncorrected detection signals via an interface to an electronic bus system. Besides this, the invention also includes a computer program and a control unit that is arranged for implementing a method according to the invention.

In the following, the invention is described in more detail on the basis of embodiment examples.

The drawings show:

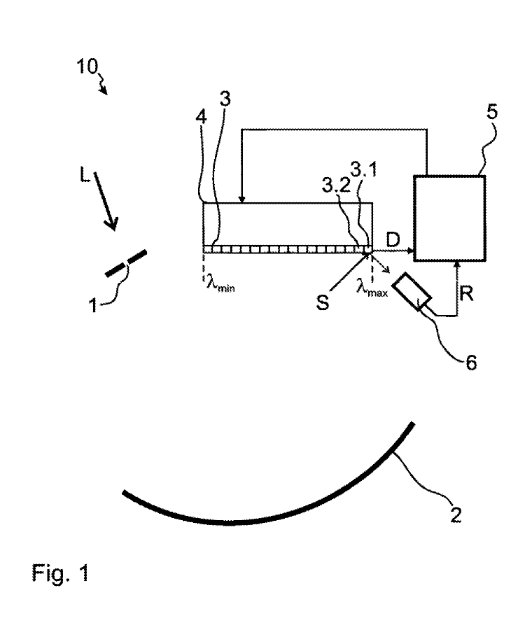

FIG. 1: a first optical spectrometer with optical reference detector,

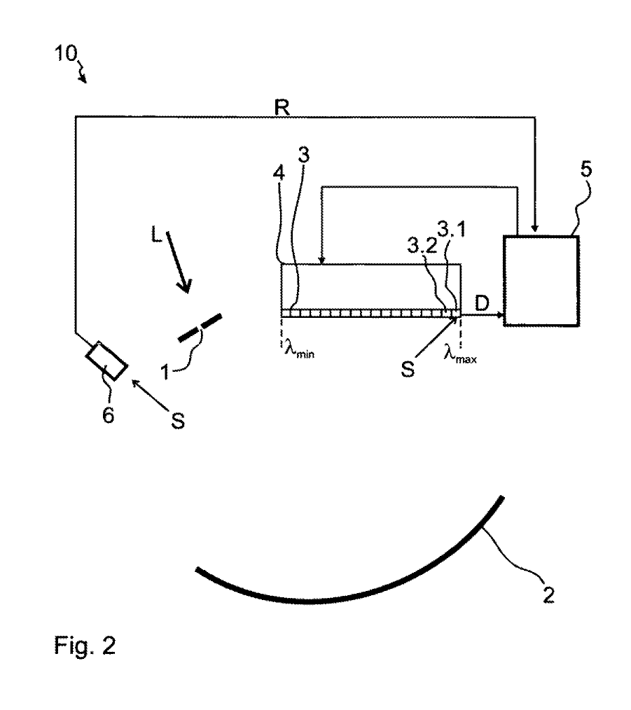

FIG. 2: a second optical spectrometer with optical reference detector,

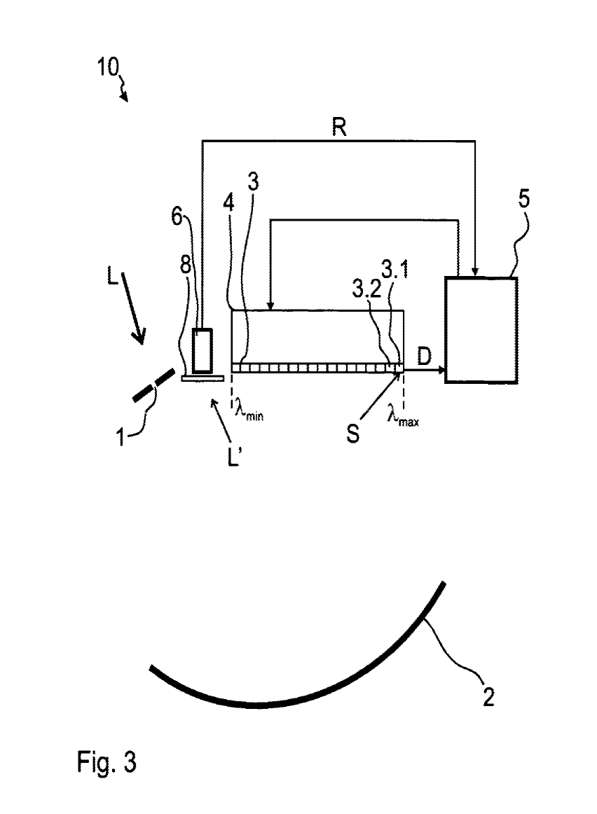

FIG. 3: a third optical spectrometer with optical reference detector, and

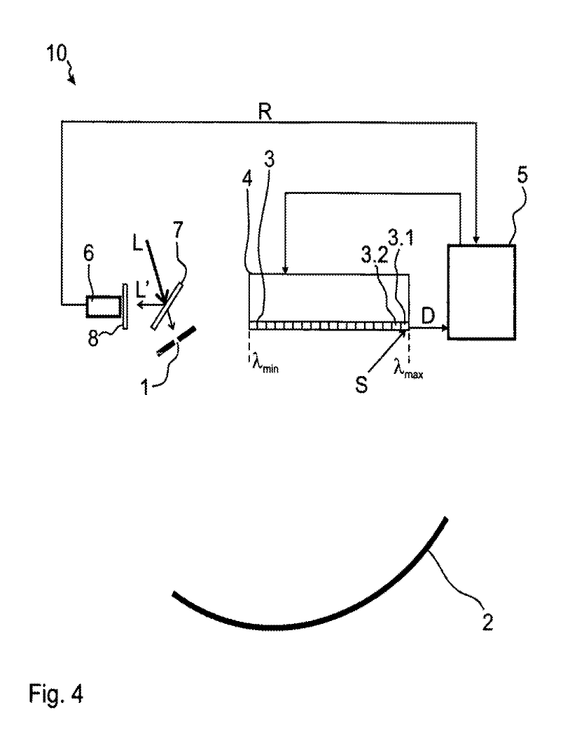

FIG. 4: a fourth optical spectrometer with optical reference detector,

In all drawings the same parts have the same reference numbers.

FIG. 1 shows the assembly according to the invention as an example of an optical spectrometer 10. Instead of this, the object of the invention can be achieved with any other spectrometer assembly especially with spectrometer assemblies according to the state of the art. For the sake of simplicity, neither a light source nor a housing nor a sample to be investigated is shown.

In the sequence of the path of light, the spectrometer 10 consists of an entrance slot 1, an imaging grating 2 and a first detector 3 that is used for the detection of different spectral sub-spectral region, lines or matrix-shaped arranged detector elements 3.1, 3.2 . . . (Pixels). In addition the first detector 3 can be equipped with a tempering unit 4, namely a heating or cooling or both. For example, in its simplest form, it is a heating resistance in the neighborhood of the first detector 3. A control and evaluation unit 5 is connected to the first detector 3 and tempering unit 4. The control and evaluation unit 5 acquires a respective detection signal Dᵢ for each detector element 3.1 and controls the tempering unit 4. For the sake of simplicity the drawing shows only a first connection in place of the whole of the detection signals. For example, the spectral region to be acquired by the spectrometer 10 is 600 nm to 1800 nm. An SI-detector is correspondingly used as a first detector 3 whose upper limiting wavelength of, for instance λₘₐₓ=1100 nm is just sufficient for acquiring the required spectral region.

For this purpose, the imaging grating 2 splits the incident light L arriving at the entrance slot 1 spectrally and depicts the entrance slot 1 on the first detector 3, which is arranged such that it only acquires spectrally split light S of the +1^{st} diffraction of the grating 2 in a spectral region λₘᵢₙ . . . λₘₐₓ. Each of its detector elements acquire one optical luminous power in a respective sub-spectral region and outputs it in the form of a respective electric detection signal Dᵢ to the control and evaluation unit 5. In this respect the structure of the spectrometer 10 is known from prior art.

Beyond the prior art, the spectrometer 10 possesses a single InGaAs detector as a reference detector 6 with a higher upper limiting wavelength than the first detector 3 of silicon. For instance, the upper limiting wavelength is 1700 nm. The reference detector 6 receives spectrally split light, S reflected from the surface of the first detector 3. Thus, a part of the incident light L is used that cannot be detected in principle by the first detector 3. Due to its surface dimension and positioning, the reference detector 6 acquires light, for instance 1040 nm to 1600 nm, which is a part region in the neighborhood of the long-wave end λₘₐₓ of the spectral region of the first detector 3. Because the reference detector 6 only possesses a single detector element, it integrates the luminous power above this part spectral region. The reference detector 6 passes the acquired luminous power in the form of a detection signal R as a temperature Independent reference to the control and evaluation unit 5.

The sensitivity of the second detector 6, at the wavelength of 1050 nm, because of the higher limiting wavelength has a significantly lower temperature dependence than the Si detector 3 so that the temperature dependence of the reference detector 6 can be ignored. The luminous power in the reference detector 6 is then in a constant relationship to the luminous power that the first detector 3 acquires in the same part region of the overall detected spectral region λₘᵢₙ . . . λₘₐₓ. The relationship of this luminous power of the two detectors 3 and 6 is therefore a relative dimension for the temperature of the first detector 3.

This temperature value can be used by the control and evaluation unit 5 for controlling the tempering unit 4, especially for regulating the heating or cooling of the first detector 3 or for the mathematical correction of the detection signal Dᵢ of the first detector 3. For this purpose, the control and evaluation unit 5 first adds up those detection signals Dᵢ of the individual detector elements 3.1 of the first detector 3 that that have a wavelength of 1040 nm to 1060 nm, i.e. the part region that corresponds to that acquired by the individual InGaAs detector 6. Then it forms the relationships of this sum ΣDᵢ to the detection signal R of the InGaAs reference detector 6 in order to define a temperature value Tᵣₑₗ=R/ΣDᵢ for the first detector 3. In the case that the sub-spectral region acquired by the relevant detector elements 3.1 do not agree exactly with the limits of the part region acquired by the reference detector 6 of the overall spectral region λₘᵢₙ . . . λₘₐₓ to be detected, then corresponding weighting factors gᵢ are used (ΣgᵢDᵢ) in the addition of the detection signal Dᵢ so that the relative temperature value is calculated as Tᵣₑₗ=R/ΣDᵢ. If the temperature of the Si first detector 3 is to be kept constant, then the heating must be reduced of the cooling increased when this relationship exceeds or falls below a prescribed nominal value for the relative temperature value Tᵣₑₗ. This can occur in a control circuit known in the industry.

The alternative mathematical correction of the detection signal Dᵢ occurs with a wavelength and temperature-independent sensitivity function provided by the detector manufacturer or determined in the climate chamber. Alternatively, it can be advantageous due to unavoidable production tolerances to measure the sensitivity curve for a concrete spectrometer 10 immediately after the switching-on of the spectrometer 10 and to measure the associated inherent heating, In addition, if available, a heating can be switched on in order to measure the wavelength and temperature-dependent sensitivity function. Under certain conditions it may be advantageous to leave an existing heating switched off during the normal measuring operation of the spectrometer 10 and only to use the mathematical sensitivity compensation because a higher detection temperature also leads to higher detector noise.

FIG. 2 shows an alternative assembly of the reference detector 6. For instance, it is arranged such that it acquires the spectrally split light S of the −1 (minus first) diffraction in a part spectral region of, for instance, 1040 nm to 1600 nm. The reference detector 6 is therefore arranged in the direction of the other diffraction of the grating 2 than the first detector 3. All other components of the spectrometer 10 correspond in assembly and function to the spectrometer 10 according to FIG. 1. In alternative embodiments (not shown), the reference detector 6, instead of being in position of the −1 diffraction, it can be arranged in the direction of a numerical higher diffraction, for instance, +2 or −2.

FIG. 3 shows a further alternative assembly of the reference detector 6 in the zero diffraction of the imaging grating 2. Also in this case the reference detector 6 is arranged in the direction of a different diffraction of the grating 2 than the first detector 3. A band pass filter 7 is arranged in front of the reference detector 6 as the incident light portion L′ on the reference detector 6 in not spectrally split in the zero diffraction. Because of the band pass filter 7, the reference detector 6 acquires only a part region of, for instance, 1040 nm to 1600 nm. All other components of the spectrometer 10 correspond in assembly and function to the spectrometer 10 in FIG. 1.

FIG. 4 shows a further alternative assembly of the reference detector 6. It is arranged in front of the entrance slot 1 behind a beam splitter 8 so than a non-spectrally split portion L′ of the incident light L is uncoupled in the direction of the detector 6. A band pass filter 7 is required so that only a part region of the, for instance, 1040 nm to 1600 nm of the spectral region λₘᵢₙ . . . λₘₐₓ the incidental light portion U of the first detector 3 is acquired. All other components of the spectrometer 10 correspond in assembly and function to the spectrometer 10 in FIG. 1. In the case of a spectrometer 10 with a fiber optic entrance (not shown) a Y-branched fiber-optic can be used in place of a beam splitter.

### REFERENCE SYMBOL LIST

1 Entrance slot
2 Imaging grating
3 First detector
3.1 . . . Detector elements
4 Tempering unit
5 Control and evaluation unit
6 Reference detector
7 Band pass filter
8 Beam splitter
10 Spectrometer
L Incident light
L′ Portion of the incident light (non-spectrally split)
S Spectrally split light
D Detection signal
R Reference signal
λₘᵢₙ Lower limiting wavelength of the first detector
λₘₐₓ Upper limiting wavelength of the first detector

1-16. (canceled)

17. An assembly, comprising:
a mechanism configured to spectrally split incident light;
a first optical detector configured to provide spectrally resolved detection of a spectral region of the split light; and
a second optical detector configured to detect a portion of the spectral region to be detected by the second optical detector,
wherein a sensitivity of the second detector to temperature is significantly less than a sensitivity of the first optical detector to temperature.

18. The assembly of claim 17, wherein the sensitivity of the second detector is independent of temperature.

19. The assembly of claim 17, wherein the assembly is an optical spectroscopy assembly.

20. The assembly of claim 17, wherein an upper limiting wavelength of the second optical detector is greater than an upper limiting wavelength of the first optical detector.

21. The assembly of claim 17, wherein the second optical detector is an indium-gallium semi-conductor detector.

22. The assembly of claim 17, wherein the portion of the spectral region is simultaneously detectable by the first and second optical detectors.

23. The assembly of claim 22, further comprising a beam splitter configured so that, during use of the assembly, the beam splitter leads a first fraction of the incident light to the first optical detector and the beam splitter leads a second fraction of the incident light to the second optical detector,
wherein the second optical detector comprises a band pass filter for the portion of the spectral region.

24. The assembly of claim 22, wherein the second optical detector is arranged so that spectrally resolved light that is reflected by the first optical detector is detectable by the second optical detector.

25. The assembly of claim 22, wherein the mechanism configured to spectrally split incident light comprises a depictive grid in which the second optical detector is arranged such that, because of the second optical detector, light is detectable in a different diffraction of the depictive grid than through the first optical detector.

26. The assembly of claim 25, wherein light of the zero diffraction is detectable by the second optical detector, and the second optical detector comprises a band pass filter for the portion of the spectral region.

27. The assembly of claim 17, further comprising a control unit configured to determine a relative temperature value for the first optical detector based on: 1) a reference signal of the second optical detector; and 2) at least one detection signal of the first optical detector corresponding to the portion of the spectral region.

28. The assembly of claim 27, wherein the control unit is configured to correct, based on the relative temperature value for the first optical detector and based on the sensitivity of the first optical detector to temperature, detection signals of the first optical detector.

29. The assembly of claim 27, wherein the control unit is configured to control a tempering unit of the first optical detector based on the relative temperature value for the first optical detector.

30. A system, comprising:
a light source; and
an assembly according to claim 17,
wherein the assembly is a spectrometer.

31. A method for determining a temperature value of a first optical detector for spectrally resolved detection of a spectral region of incident light, the method comprising:
determining, via the first optical detector, a detection signal for a portion of the spectral region;
determining, via a second optical detector, a reference signal for the portion of the spectral region; and
determining, based on the detection signal and the reference signal, a relative temperature value for the first optical detector,
wherein a sensitivity of the second detector to temperature is significantly less than a sensitivity of the first optical detector to temperature.

32. The method of claim 31, further comprising, based on the relative temperature value for the first optical detector and based on the sensitivity of the first optical detector to temperature, correcting detection signals of the first optical detector.

33. The method of claim 31, further comprising controlling a tempering unit for the first optical detector based on the relative temperature value for the first optical detector.

34. The method of claim 31, further comprising determining the temperature value as a quotient from the reference signal and the detection signal.

35. The method of claim 31, further comprising measuring a sensitivity function of the first optical detector during a warming-up process or after a warming-up process.

36. A computer program product tangibly embodied in a computer readable medium comprising instructions to cause a computer to:
determine a temperature value of a first optical detector for spectrally resolved detection of a spectral region of incident light by:
determining, via the first optical detector, a detection signal for a portion of the spectral region;
determining, via a second optical detector, a reference signal for the portion of the spectral region; and
determining, based on the detection signal and the reference signal, a relative temperature value for the first optical detector,
wherein a sensitivity of the second detector to temperature is significantly less than a sensitivity of the first optical detector to temperature.
